(19) United States
(12) Patent Application Publication
(10) Pub. No.: US 2019/0178523 A1
(43) Pub. Date: Jun. 13, 2019

(54) THERMOSTAT WITH OCCUPANCY MODELING

(71) Applicant: Johnson Controls Technology Company, Auburn Hills, MI (US)

(72) Inventors: Nathan M. Zimmerman, Wauwatosa, WI (US); Michael J. Ajax, Milwaukee, WI (US)

(73) Assignee: Johnson Controls Technology Company, Auburn Hills, MI (US)

(21) Appl. No.: 16/139,794

(22) Filed: Sep. 24, 2018

Related U.S. Application Data
(60) Provisional application No. 62/595,776, filed on Dec. 7, 2017.

(51) Int. Cl. F24F 11/66; G06N 7/00; G06N 99/00; F24F 11/523

(52) U.S. Cl. CPC F24F 11/66; G06N 7/00; F24F 2120/14; F24F 11/523; G06N 99/005

(57) ABSTRACT

The present disclosure includes a thermostat for controlling HVAC equipment of a building based on occupancy of the building. The thermostat includes an occupancy sensor configured to detect a presence of an occupant. The thermostat includes a processing circuit. The processing circuit can receive occupancy data for one or more points in time from an occupancy sensor. The occupancy data indicates the presence of an occupant at the one or more points in time. The a processing circuit can train an occupancy model based on the occupancy data, wherein the occupancy model predicts a probability of the presence of the occupant

### CROSS-REFERENCE TO RELATED APPLICATION

This application claims the benefit of the following provisionally filed U.S. patent application: Application No. 62/595,776, filed Dec. 7, 2017, and entitled “Thermostat with Occupancy Modeling,” which application is hereby incorporated herein by reference.

### BACKGROUND

A thermostat, in general, is a component of an HVAC control system. Thermostats sense the temperature or other parameters (e.g., humidity) of a system and control components of the HVAC system to maintain a set point for the temperature or other parameter. A thermostat may be designed to control a heating or cooling system or an air conditioner. Thermostats use a variety of sensors to detect occupancy so as to better control the HVAC system. The term HVAC system refers to a system with equipment that provides heating, cooling, or ventilation in this application.

### SUMMARY

One embodiment of the present disclosure includes a thermostat for controlling HVAC equipment of a building based on occupancy of the building. The thermostat includes an occupancy sensor configured to detect a presence of an occupant. The thermostat includes a processing circuit. The processing circuit can receive occupancy data for one or more points in time from an occupancy sensor. The occupancy data indicates the presence of an occupant at the one or more points in time. The processing circuit can train an occupancy model based on the occupancy data. The occupancy model predicts a probability of the presence of the occupant.

Another embodiment of the present disclosure includes a method. The method includes receiving occupancy data for one or more points in time from an occupancy sensor. The occupancy data indicates a presence of one or more occupants at the one or more points in time in a building space. The method includes updating an occupancy model based on the occupancy data. The occupancy model predicts a probability of the presence of the one or more occupants.

Yet another embodiment of the present disclosure includes a thermostat for controlling HVAC equipment of a building based on occupancy of the building. The thermostat includes an occupancy sensor configured to detect an occupant in a building space. The thermostat includes a processing circuit. The processing circuit can receive data from the occupancy sensor indicating whether the occupant is at presence in the building space over a number of time bins. The processing circuit can train an occupancy model based on the data by subsequently determining a probability of presence of the occupant at a first one of the time bins based on whether the occupant has been at presence in the building space over at least one of the time bins, which is prior to the first one of the time bins, and over at least one of time bins, which is subsequent to the first one of the time bins, and predicting a probability of presence of the occupant at the first one of the time bins in a future using the determined probability of presence of the occupant.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a drawing of a thermostat with a transparent display and an occupancy sensor, according to an exemplary embodiment.

FIG. 1B is a schematic drawing of a building equipped with a residential heating and cooling system and the thermostat of FIG. 1A, according to an exemplary embodiment.

FIG. 2 is a schematic drawing of the thermostat and the residential heating and cooling system of FIG. 1A, according to an exemplary embodiment.

FIG. 3 is a block diagram of the thermostat of FIG. 1A shown to include an occupancy model, according to an exemplary embodiment.

FIG. 4 is a chart illustrating the occupancy model of the thermostat of FIG. 3, according to an exemplary embodiment.

FIG. 5 is a flow diagram illustrating a process for using the occupancy model of the thermostat of FIG. 3, according to an exemplary embodiment.

FIG. 6 is a chart illustrating occupancy data that can be used to train the occupancy model of the thermostat of FIG. 3, according to an exemplary embodiment.

FIG. 7 is a chart illustrating the performance of the occupancy model of the thermostat of FIG. 3, according to an exemplary embodiment.

FIG. 8 is a chart illustrating the performance of a rolling average for occupancy prediction, according to an exemplary embodiment.

FIG. 9 is a chart illustrating the performance of a model trained with recursive least squares, according to an exemplary embodiment.

### DETAILED DESCRIPTION

### Overview

Significant energy may be wasted when a thermostat is regulating the temperature of an un-occupied building. Often, thermostats needlessly waste energy as a result of not correctly determining occupancy. This failure may be due to not having occupancy sensors or due to the accurate sensing issues associated with common occupancy sensors such as, passive infrared (PIR) sensors. PIR occupancy sensors may require an occupant to walk past them and may not determine occupancy properly if an occupant is in another room (e.g., a room other than the room where the thermostat is located).

Occupants may not walk past their thermostat for hours on a normal basis even if they are in the building that the thermostat is located in. Consequently, for HVAC systems of the building to properly operate, the thermostat often includes a long timeout duration that where the user is considered present even though a detection event has not occurred in a while. Poor occupancy detection can also result in user discomfort due to the thermostat shutting off or shutting off HVAC equipment when a user is present but has not walked past the occupancy sensor recently.

The systems and methods discussed herein, according to some embodiments, create a stochastic model for a thermostat that the thermostat can learn over time. A duration of timeout can then be adjusted by the thermostat according to the probability of the space being occupied. The thermostat can extend or shorten the timeout based upon occupancy probability which may result in energy conservation. Further, the thermostat can, according to some embodiments, efficiently reduce phase delay and can train the model over time to adapt to occupancy patterns.

The thermostat can use an occupancy data source (e.g., a PIR sensor), despite inaccurate, and supplemental data (e.g., data from other sensors) to make occupancy determinations. Further, the thermostat can use historical occupancy data to make determinations regarding occupancy. Making optimal use of PIR data can be a complex problem since the PIR data may be biased towards false negatives (e.g., the thermostat determines that an occupant is not present when an occupant is in fact present). To compensate for these false negatives, Bayesian signal processing can be used by the thermostat to take into account prior information collected by the thermostat for past weeks as well as the tendency of the sensor towards false negatives (i.e., determining that there is no occupancy when there is in fact an occupant present).

One issue with filtering to predict occupancy is that it can introduce phase delay. Any delay in this system can result in wasted energy. Consequently, a non-casual filter (e.g., nontraditional filtering mechanism that operates on future data as opposed to only the past) can be used to achieve minimal phase delay.

The occupancy model of the thermostat can output the probability of human occupancy for a residency based on a passive infrared sensor (PIR) sensor and/or any other type of occupancy sensor. The model can compensate for the common deficiencies of PIR based occupancy sensors. Further, the model can adapt to changing occupancy patterns over time. The output of the occupancy model can be a probability and can be split up into 15 minute bins for a given week.

The occupancy model allows the thermostat to create and/or learn an occupancy schedule. Further, the occupancy model can allow the thermostat to correct and/or optimize an occupancy schedule that a user may program into the thermostat. In some embodiment, the occupancy model can allow the thermostat to forecast and/or predict equipment load demand and compensate for the imperfections of occupancy sensors. The occupancy model can create adjustable time-outs based upon the models occupancy probability.

Fundamentally, this model can be used because there may be no perfect occupancy sensor. This model can compensate for the deficiencies of a PIR sensor which is a commonly used occupancy sensor. A PIR sensor may give an inaccurate reading since the thermostat may not be located in the same room as the occupant(s). Depending upon the setup, occupants may only rarely cross in front of the sensor. Secondly, if an occupant is stationary in front of a sensor, such as sitting, the sensor may fail to detect the occupancy. Due to the inaccuracies of a PIR sensor, it is common that rooms controlled by devices with PIR sensors go into an un-occupied state when occupants are present. To compensate for this, mathematical modeling can be used based upon historical data.

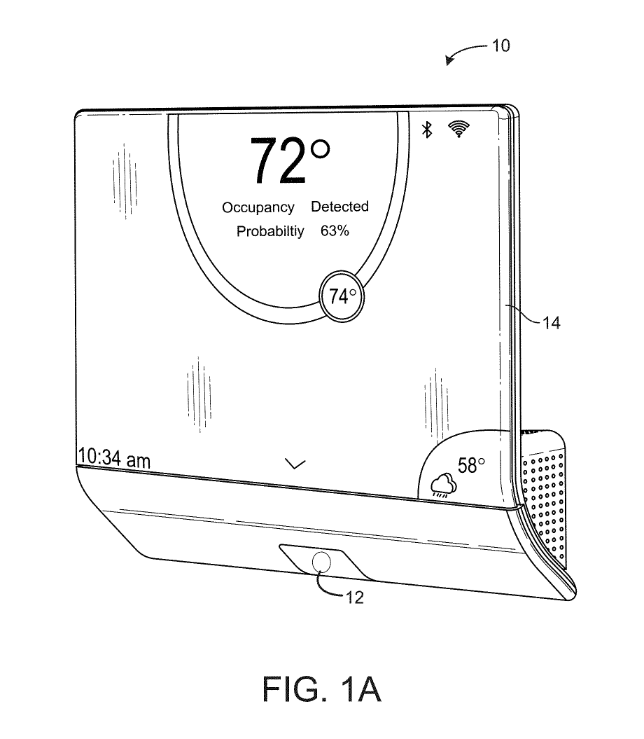

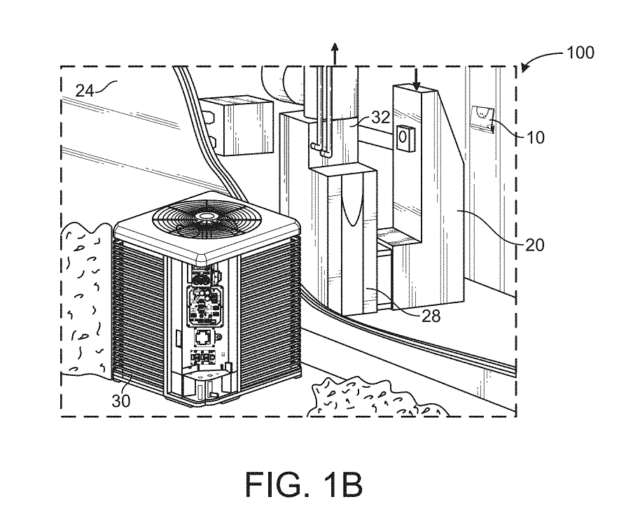

FIG. 1A is a drawing of a thermostat 10 that includes an occupancy sensor 12 and a display 14. The occupancy sensor 12 may be a passive infrared (PIR) sensor, a microwave sensor, an ultrasonic sensor, and/or any other type of sensor that can be configured to detect the presence of an occupant. The occupancy sensor may be located behind a window as shown in FIG. 1A. The thermostat 10 is shown to include a display 14. The display 14 may be an interactive display that can display information to a user and receive input from the user. The display may be transparent such that a user can view information on the display and view the surface located behind the display. Thermostats with transparent and cantilevered displays are described in further detail in U.S. patent application Ser. No. 15/146,649 filed May 4, 2016, the entirety of which is incorporated by reference herein.

The display 14 can be a touchscreen or other type of electronic display configured to present information to a user in a visual format (e.g., as text, graphics, etc.) and receive input from a user (e.g., via a touch-sensitive panel). For example, the display 14 may include a touch-sensitive panel layered on top of an electronic visual display. A user can provide inputs through simple or multi-touch gestures by touching the display 14 with one or more fingers and/or with a stylus or pen. The display 14 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of display 14 allowing registration of touch in two or even more locations at once. The display may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoS), or any other display technologies known in the art. In some embodiments, the display 14 is configured to present visual media (e.g., text, graphics, etc.) without requiring a backlight.

Via the occupancy sensor 12, the thermostat 10 can be configured to determine whether an occupant is present in the environment where the thermostat 10 is located. The thermostat 10 can be configured to use the various occupancy modeling techniques discussed herein to determine whether an occupant is present and/or a probability that an occupant is present. The thermostat 10 may use the determination that an occupant is present and/or the probability that an occupant is present to perform various energy savings functions such as adjusting timeout durations.

FIG. 1B illustrates a residential heating and cooling system 100, such as an HVAC system. The residential heating and cooling system 100 may provide heated and cooled air to a residential structure. Although described as a residential heating and cooling system 100, embodiments of the systems and methods described herein can be utilized in a cooling unit or a heating unit in a variety of applications include commercial HVAC units (e.g., roof top units). In general, a residence 24 includes refrigerant conduits that operatively couple an indoor unit 28 to an outdoor unit 30. Indoor unit 28 may be positioned in a utility space, an attic, a basement, and so forth. Outdoor unit 30 is situated adjacent to a side of residence 24. Refrigerant conduits transfer refrigerant between indoor unit 28 and outdoor unit 30, typically transferring primarily liquid refrigerant in one direction and primarily vaporized refrigerant in an opposite direction.

When the system 100 shown in FIG. 1B is operating as an air conditioner, a coil in outdoor unit 30 serves as a condenser for recondensing vaporized refrigerant flowing from indoor unit 28 to outdoor unit 30 via one of the refrigerant conduits. In these applications, a coil of the indoor unit 28, designated by the reference numeral 32, serves as an evaporator coil. Evaporator coil 32 receives liquid refrigerant (which may be expanded by an expansion device, not shown) and evaporates the refrigerant before returning it to outdoor unit 30.

Outdoor unit 30 draws in environmental air through its sides, forces the air through the outer unit coil using a fan, and expels the air. When operating as an air conditioner, the air is heated by the condenser coil within the outdoor unit 30 and exits the top of the unit at a temperature higher than it entered the sides. Air is blown over indoor coil 32 and is then circulated through residence 24 by means of ductwork 20, as indicated by the arrows entering and exiting ductwork 20. The overall system 100 operates to maintain a desired temperature as set by thermostat 10. When the temperature sensed inside the residence 24 is higher than the set point on the thermostat 10 (with the addition of a relatively small tolerance), the air conditioner will become operative to refrigerate additional air for circulation through the residence 24. When the temperature reaches the set point (with the removal of a relatively small tolerance), the unit can stop the refrigeration cycle temporarily.

In some embodiments, the system 100 configured so that the outdoor unit 30 is controlled to achieve a more elegant control over temperature and humidity within the residence 24. The outdoor unit 30 is controlled to operate components within the outdoor unit 30, and the system 100, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

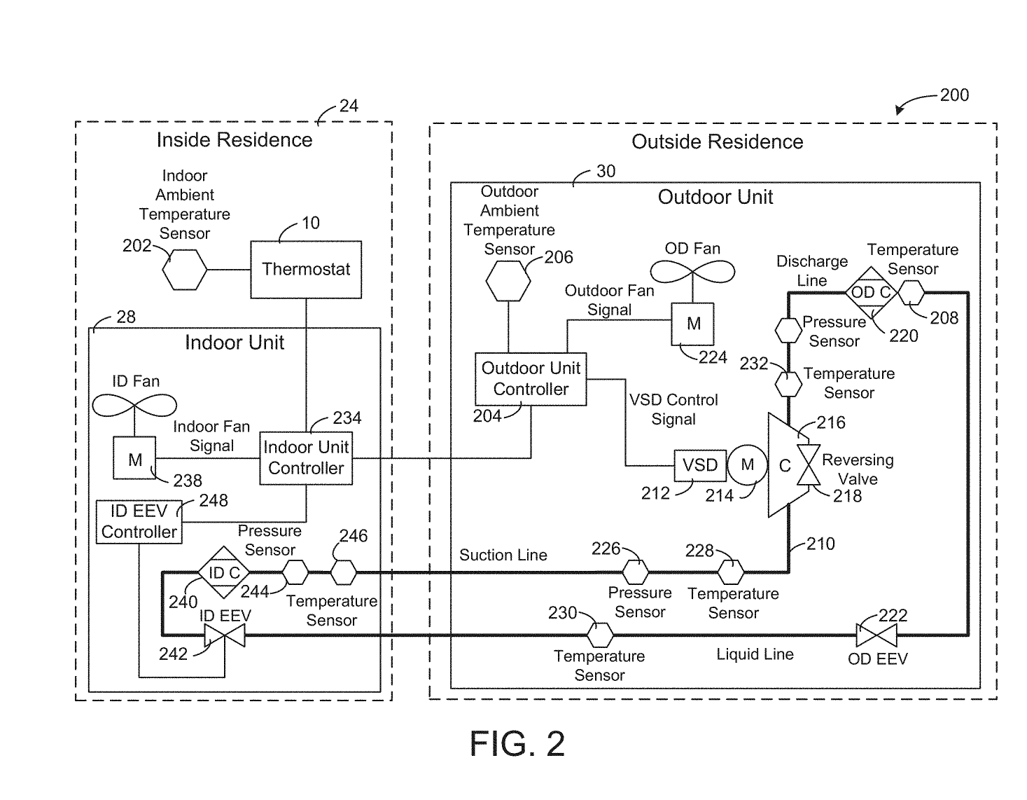

Referring now to FIG. 2, an HVAC system 200 is shown according to an exemplary embodiment. Various components of system 200 are located inside residence 24 while other components are located outside residence 24. Outdoor unit 30, as described with reference to FIG. 1B, is shown to be located outside residence 24 while indoor unit 28 and thermostat 10, as described with reference to FIG. 1B, are shown to be located inside the residence 24. In various embodiments, the thermostat 10 can cause the indoor unit 28 and the outdoor unit 30 to heat residence 24. In some embodiments, the thermostat 10 can cause the indoor unit 28 and the outdoor unit 30 to cool the residence 24. In other embodiments, the thermostat 10 can command an airflow change within the residence 24 to adjust the humidity within the residence 24.

Thermostat 10 can be configured to generate control signals for indoor unit 28 and/or outdoor unit 30. The thermostat 10 is shown to be connected to an indoor ambient temperature sensor 202, and an outdoor unit controller 204 is shown to be connected to an outdoor ambient temperature sensor 206. The indoor ambient temperature sensor 202 and the outdoor ambient temperature sensor 206 may be any kind of temperature sensor (e.g., thermistor, thermocouple, etc.). The thermostat 10 may measure the temperature of residence 24 via the indoor ambient temperature sensor 202. Further, the thermostat 10 can be configured to receive the temperature outside residence 24 via communication with the outdoor unit controller 204. In various embodiments, the thermostat 10 generates control signals for the indoor unit 28 and the outdoor unit 30 based on the indoor ambient temperature (e.g., measured via indoor ambient temperature sensor 202), the outdoor temperature (e.g., measured via the outdoor ambient temperature sensor 206), and/or a temperature set point.

The indoor unit 28 and the outdoor unit 30 may be electrically connected. Further, indoor unit 28 and outdoor unit 30 may be coupled via conduits 210. The outdoor unit 30 can be configured to compress refrigerant inside conduits 210 to either heat or cool the building based on the operating mode of the indoor unit 28 and the outdoor unit 30 (e.g., heat pump operation or air conditioning operation). The refrigerant inside conduits 210 may be any fluid that absorbs and extracts heat. For example, the refrigerant may be hydro fluorocarbon (HFC) based R-410A, R-407C, and/or R-134a.

The outdoor unit 30 is shown to include the outdoor unit controller 204, a variable speed drive 212, a motor 214 and a compressor 216. The outdoor unit 30 can be configured to control the compressor 216 and to further cause the compressor 216 to compress the refrigerant inside conduits 210. In this regard, the compressor 216 may be driven by the variable speed drive 212 and the motor 214. For example, the outdoor unit controller 204 can generate control signals for the variable speed drive 212. The variable speed drive 212 (e.g., an inverter, a variable frequency drive, etc.) may be an AC-AC inverter, a DC-AC inverter, and/or any other type of inverter. The variable speed drive 212 can be configured to vary the torque and/or speed of the motor 214 which in turn drives the speed and/or torque of compressor 216. The compressor 216 may be any suitable compressor such as a screw compressor, a reciprocating compressor, a rotary compressor, a swing link compressor, a scroll compressor, or a turbine compressor, etc.

In some embodiments, the outdoor unit controller 204 is configured to process data received from the thermostat 10 to determine operating values for components of the system 100, such as the compressor 216. In one embodiment, the outdoor unit controller 204 is configured to provide the determined operating values for the compressor 216 to the variable speed drive 212, which controls a speed of the compressor 216. The outdoor unit controller 204 is controlled to operate components within the outdoor unit 30, and the indoor unit 28, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

In some embodiments, the outdoor unit controller 204 can control a reversing valve 218 to operate system 200 as a heat pump or an air conditioner. For example, the outdoor unit controller 204 may cause reversing valve 218 to direct compressed refrigerant to the indoor coil 32 while in heat pump mode and to an outdoor coil 220 while in air conditioner mode. In this regard, the indoor coil 32 and the outdoor coil 220 can both act as condensers and evaporators depending on the operating mode (i.e., heat pump or air conditioner) of system 200.

Further, in various embodiments, outdoor unit controller 204 can be configured to control and/or receive data from an outdoor electronic expansion valve (EEV) 222. The outdoor electronic expansion valve 222 may be an expansion valve controlled by a stepper motor. In this regard, the outdoor unit controller 204 can be configured to generate a step signal (e.g., a PWM signal) for the outdoor electronic expansion valve 222. Based on the step signal, the outdoor electronic expansion valve 222 can be held fully open, fully closed, partial open, etc. In various embodiments, the outdoor unit controller 204 can be configured to generate step signal for the outdoor electronic expansion valve 222 based on a subcool and/or superheat value calculated from various temperatures and pressures measured in system 200. In one embodiment, the outdoor unit controller 204 is configured to control the position of the outdoor electronic expansion valve 222 based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit controller 204 can be configured to control and/or power outdoor fan 224. The outdoor fan 224 can be configured to blow air over the outdoor coil 220. In this regard, the outdoor unit controller 204 can control the amount of air blowing over the outdoor coil 220 by generating control signals to control the speed and/or torque of outdoor fan 224. In some embodiments, the control signals are pulse wave modulated signals (PWM), analog voltage signals (i.e., varying the amplitude of a DC or AC signal), and/or any other type of signal. In one embodiment, the outdoor unit controller 204 can control an operating value of the outdoor fan 224, such as speed, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit 30 may include one or more temperature sensors and one or more pressure sensors. The temperature sensors and pressure sensors may be electrical connected (i.e., via wires, via wireless communication, etc.) to the outdoor unit controller 204. In this regard, the outdoor unit controller 204 can be configured to measure and store the temperatures and pressures of the refrigerant at various locations of the conduits 210. The pressure sensors may be any kind of transducer that can be configured to sense the pressure of the refrigerant in the conduits 210. The outdoor unit 30 is shown to include pressure sensor 226. The pressure sensor 226 may measure the pressure of the refrigerant in conduit 210 in the suction line (i.e., a predefined distance from the inlet of compressor 216. Further, the outdoor unit 30 is shown to include pressure sensor 226. The pressure sensor 226 may be configured to measure the pressure of the refrigerant in conduits 210 on the discharge line (e.g., a predefined distance from the outlet of compressor 216).

The temperature sensors of outdoor unit 30 may include thermistors, thermocouples, and/or any other temperature sensing device. The outdoor unit 30 is shown to include temperature sensor 208, temperature sensor 228, temperature sensor 230, and temperature sensor 232. The temperature sensors (i.e., temperature sensor 208, temperature sensor 228, temperature sensor 230, and/or temperature sensor 232) can be configured to measure the temperature of the refrigerant at various locations inside conduits 210.

Referring now to the indoor unit 28, the indoor unit 28 is shown to include indoor unit controller 234, indoor electronic expansion valve controller 236, an indoor fan 238, an indoor coil 240, an indoor electronic expansion valve 242, a pressure sensor 244, and a temperature sensor 246. The indoor unit controller 234 can be configured to generate control signals for indoor electronic expansion valve controller 248. The signals may be set points (e.g., temperature set point, pressure set point, superheat set point, subcool set point, step value set point, etc.). In this regard, indoor electronic expansion valve controller 248 can be configured to generate control signals for indoor electronic expansion valve 242. In various embodiments, indoor electronic expansion valve 242 may be the same type of valve as outdoor electronic expansion valve 222. In this regard, indoor electronic expansion valve controller 248 can be configured to generate a step control signal (e.g., a PWM wave) for controlling the stepper motor of the indoor electronic expansion valve 242. In this regard, indoor electronic expansion valve controller 248 can be configured to fully open, fully close, or partially close the indoor electronic expansion valve 242 based on the step signal.

Indoor unit controller 234 can be configured to control indoor fan 238. The indoor fan 238 can be configured to blow air over indoor coil 32. In this regard, the indoor unit controller 234 can control the amount of air blowing over the indoor coil 240 by generating control signals to control the speed and/or torque of the indoor fan 238. In some embodiments, the control signals are pulse wave modulated signals (PWM), analog voltage signals (i.e., varying the amplitude of a DC or AC signal), and/or any other type of signal. In one embodiment, the indoor unit controller 234 may receive a signal from the outdoor unit controller indicating one or more operating values, such as speed for the indoor fan 238. In one embodiment, the operating value associated with the indoor fan 238 is an airflow, such as cubic feet per minute (CFM). In one embodiment, the outdoor unit controller 204 may determine the operating value of the indoor fan based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The indoor unit controller 234 may be electrically connected (e.g., wired connection, wireless connection, etc.) to pressure sensor 244 and/or temperature sensor 246. In this regard, the indoor unit controller 234 can take pressure and/or temperature sensing measurements via pressure sensor 244 and/or temperature sensor 246. In one embodiment, pressure sensor 244 and temperature sensor 246 are located on the suction line (i.e., a predefined distance from indoor coil 32). In other embodiments, the pressure sensor 244 and/or the temperature sensor 246 may be located on the liquid line (i.e., a predefined distance from indoor coil 32).

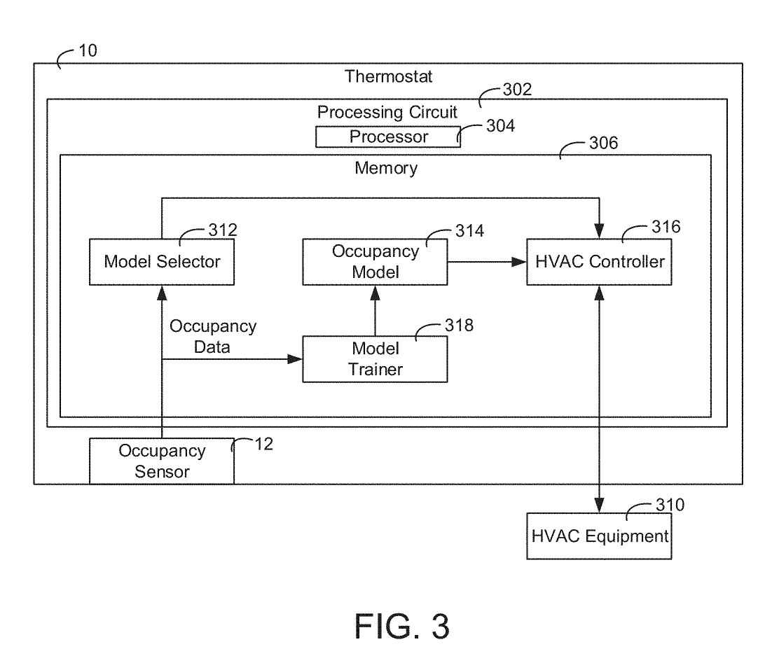

Referring now to FIG. 3, the thermostat 10 as described with reference to FIGS. 1-2 is shown in greater detail, according to an exemplary embodiment. The thermostat 10 is shown to include a processing circuit 302 and the occupancy sensor 12. The occupancy sensor 12 can be configured to communicate occupancy data to the processing circuit 302, the occupancy data indicating whether the occupancy sensor 12 has detected an occupant. The occupancy sensor may be a passive infrared (PIR) sensor, a microwave sensor, an ultrasonic sensor, and/or any other type of sensor.

The processing circuit 302 is shown to include a processor 304 and a memory 306. The processor 304 can be a general purpose or specific purpose processor, an application specific integrated circuit (ASIC), one or more field programmable gate arrays (FPGAs), a group of processing components, or other suitable processing components. The processor 304 may be configured to execute computer code and/or instructions stored in the memory 306 or received from other computer readable media (e.g., CDROM, network storage, a remote server, etc.).

The memory 306 can include one or more devices (e.g., memory units, memory devices, storage devices, etc.) for storing data and/or computer code for completing and/or facilitating the various processes described in the present disclosure. The memory 306 can include random access memory (RAM), read-only memory (ROM), hard drive storage, temporary storage, non-volatile memory, flash memory, optical memory, or any other suitable memory for storing software objects and/or computer instructions. The memory 306 can include database components, object code components, script components, or any other type of information structure for supporting the various activities and information structures described in the present disclosure. The memory 306 can be communicably connected to the processor 304 via the processing circuit 302 and can include computer code for executing (e.g., by the processor 304) one or more processes described herein.

The memory 306 is shown to include a model selector 312, an occupancy model 314, an HVAC controller 316, and a model trainer 318. The model selector 312 can be configured to receive occupancy data from the occupancy sensor 12. The model selector 312 can be configured to cause the HVAC controller 316 to operate via the occupancy predicted by the occupancy model 314 or ignore the occupancy model 314. The model selector 312 can be configured to enable and/or disable the occupancy model 314.

For example, at night, the occupancy model 314 may determine that there are no occupants in the house because no occupants are detected. However, this may be in error since the occupants may be at home but are asleep. For this reason, the model selector 312 can be configured to disable the occupancy model 314 and cause the HVAC controller 316 to operate based on a night time schedule. Further, if the model selector 312 determines that the occupancy sensor 12 detecting occupancy during a fifteen minute interval, the model selector 312 can be configured to cause the HVAC controller 316 to operate as if there is occupancy regardless of any occupancy determination of the occupancy model 314 during the fifteen minute interval where occupancy was detected. If no occupancy is determined the model selector 312 can be configured to cause the HVAC controller 316 to operate based on the predicted occupancy of the occupancy model 314. This is described in further detail in the process described in FIG. 5.

The occupancy model 314 is a model that can be used to predict occupancy in some embodiments. The occupancy model 314 is configured to communicate predicted occupancy with the HVAC controller 316 in some embodiments. The occupancy model 314 is a stochastic model (since occupancy may be a stochastic problem) that is implemented based on known occupancy data in some embodiments. In an example where the occupancy sensor 12 is a PIR sensor, it may be known that if the PIR sensor senses an occupant, the probability of occupancy is 1 (e.g., 100% certainty of occupancy).

TABLE 1
Event Probability For A PIR Sensor

| Event | Probability |
|---|---|
| Occupancy \| PIR = 1 | 1 |

Given the PIR sensor is reading occupied, it can be assumed that there is an occupant present. This assumes negligible false positives. However, given the PIR sensor is reading vacant, in some embodiments, no certain probability can be determined. If the occupant is stationary, or if the occupant is not in the line-of-sight of the PIR sensor, the PIR sensor may read vacant. This is a fairly common occurrence in the use of PIR sensors though the exact probability may depend upon the mounting and the activity pattern of occupant(s).

TABLE 2
Event Probability For A PIR Sensor

| Event | Probability |
|---|---|
| Occupancy \| PIR = 0 | ? |

Consequently, this distribution of the probability of occupancy given that the PIR sensor does not detect an occupant can be modeled similar to a binomial distribution. Given the error pattern of the PIR sensor is binomial and not normal or uniform, it can be difficult to use traditional methods such as a Kalman filter or other methods that attempt to reduce the mean-squared-error. Furthermore, the difficulty may be compounded by the fact that the correct answer is never known. Consequently, many forms of machine learning may not be possible for modeling occupancy.

The occupancy model 314 is based on conditional probability and may assume that the probability of current occupancy is influenced by past and future occupancy data in some embodiments. For example, if there was recent occupancy data, it may be more likely a room is occupied than if the room had been vacant for the past hour. For the occupancy model 314, occupancy periods are broken up into 15 minute bins where k represents the current bin and current probability p(k) with occupancy data x(k) in some embodiments. The probability of the current instance p(k) is correlated to nearby samples such as x(k+1) or x(k−1) in some embodiments.

Consequently, a categorical distribution can be assigned to a particular data point (e.g., p(k)) depending upon how recently occupancy was sensed in the past and future according to Table 3.

TABLE 3
Occupancy Probability For Past and Future Tinies

| Nearest | Probability (p(k) given x |
|---|---|
| k Occupancy | occupancy data) |
| k = 0 | 1 |
| k = ±1 | 0.8 |
| k = ±2 | 0.6 |
| \|k\| > 2 | 0.2 |

This distribution operates on future data, i.e., the occupancy model 314 is non-causal, so the calculation of occupancy for the occupancy model 314 may be done in post processing in some embodiments.

The model trainer 318 is configured to update the occupancy model 314 over time in some embodiments. The model trainer 318 is configured to update the model with a rolling average/low pass filter in some embodiments. The occupancy model 314 is trained and/or updated for 15 minute bins of a week in some embodiments. This may allow the occupancy model 314 to adapt over time for changes in occupancy patterns. The model trainer 318 can be configured to use the rolling average of Equation 1 below,

p(k+1)=p(k)+gain*(x(k)−p(k)) (Equation 1)

where p(k) represents the occupancy probability of a certain time bin during a first (e.g., previous) week, x(k) represents the occupancy probability of the certain time bin during a second (e.g., current) week, the gain can be predefined as any number, and p(k+1) represents the occupancy probability of the certain time bin during a third (e.g., next) week. In some embodiments, x(k) may be determined according to the above-described Table 3. In some embodiments, the gain (e.g., gain/cutoff frequency) is predefined as 0.25.

The HVAC controller 316 can be configured to use the occupancy model 314 to control the HVAC equipment 310. The HVAC equipment 310 may be any kind of HVAC equipment. The HVAC equipment 310 can be configured to cause an environmental change in the residence 24. The HVAC equipment 310 can be the outdoor unit 30 and/or the indoor unit 28 as described with reference to FIGS. 1-2. The thermostat 10 can be located in a house, an apartment, an office building, a sky-rise, etc. The HVAC equipment 310 may be residential HVAC equipment such as the HVAC equipment described with reference to FIGS. 1-2. In some embodiments, the HVAC equipment can be industrial HVAC equipment such as airside systems, waterside systems, etc. Examples of such systems can be found in detail in U.S. patent application Ser. No. 15/338,215 filed Oct. 28, 2016, the entirety of which is incorporated by reference herein.

The HVAC controller 316 can be configured to use various types of control algorithms for controlling the HVAC equipment 310. The HVAC controller 316 can be configured to use feedback control algorithms (e.g., PID, PI, P algorithms), model predictive control (MPC), and/or any other type of control algorithm for controlling the HVAC equipment 310 to achieve a particular temperature (e.g., a setpoint temperature) in the residence 24.

The HVAC controller 316 can be configured to control the HVAC equipment 310 based on schedules and/or adjustable timeouts. The timeout may be a time period in which the thermostat 10 does not detect occupancy and then switches from a home mode (e.g., a mode in which the thermostat 10 uses energy and controls temperature in the building via the HVAC equipment) to a away mode (e.g., a mode in which the thermostat 10 does not use energy or control temperature in the building via HVAC equipment). The adjustable home-to-away timeouts can help to avoid user frustration with the operation of thermostat 10 (e.g., the thermostat 10 not running when the occupant is at home and running when the occupant is not at home). The home-to-away timeout may be a length of time in which no occupancy is detected for the HVAC controller 316 to adjust operating mode of the thermostat 10 from home to away (e.g., running equipment (home) to not running equipment (away)). Some thermostats may use a fixed timeout period such as 30 minutes which may be overly aggressive and turn off while a user is present. Some thermostats may have a longer timeout (e.g., 1-2 hours) which would be wasteful in terms of energy.

Based on the occupancy model 314, the HVAC controller 316 can be configured to use predicted occupancy and the adjustable home-to-away timeout to control the HVAC equipment 310. The HVAC controller 316 can be configured to adjust the thermostat home-to-away timeout between 15 minutes and 2 hours based upon the occupancy determined by the occupancy model 314. If, based on the occupancy model 314, it is highly unlikely a user would be present, the home-to-away timeout could be 15 minutes. The other extreme is if it is highly likely that a user is present, the home-to-away timeout is extended to 2 hours to avoid going away while a user has been historically always present.

There may be a linear, non-linear relation, or any other relationship that correlates occupancy predicted by the occupancy model 314 to a length of time for the home-to-away timeout period. In some embodiments, the HVAC controller 316 may use the occupancy probability predicted for one or more of the following weeks to adjust the home-to-away timeout. For example, given an occupancy probability of a time bin (e.g., 3:45 AM to 4:00 AM) on Monday during a prior week, p(k), is 0.5, if the PIR sensor has detected occupancy (e.g., the presence of one or more occupants) within ±30 minutes of the time bin on Monday during a current week, based on Table 3, x(k) can be determined as 0.6. Based on Equation 1, p(k+1) can be determined as 0.525 (because 0.5+0.25×(0.6−0.5)). The HVAC controller 316 can use this predicted probability, 0.525, to estimate a timeout threshold for the time bin on Monday of the next week. For example, the HVAC controller 316 can estimate a timeout threshold for the time bin on Monday of the next week as,

0.525×(predefined max timeout−predefined min timeout)+predefined min timeout.

The predefined max and min timeouts can be 2 hours and 15 minutes, respectively, which leads the timeout threshold for the time bin from 3:45 AM to 4:00 AM on Monday during the next week to be 70.125 minutes in some embodiments. As such, during 3:45 AM to 4:00 AM on Monday during the next week, if the time since last occupancy is greater than 70.125 minutes, the HVAC controller 316 may switch the HVAC equipment 310 to the away mode.

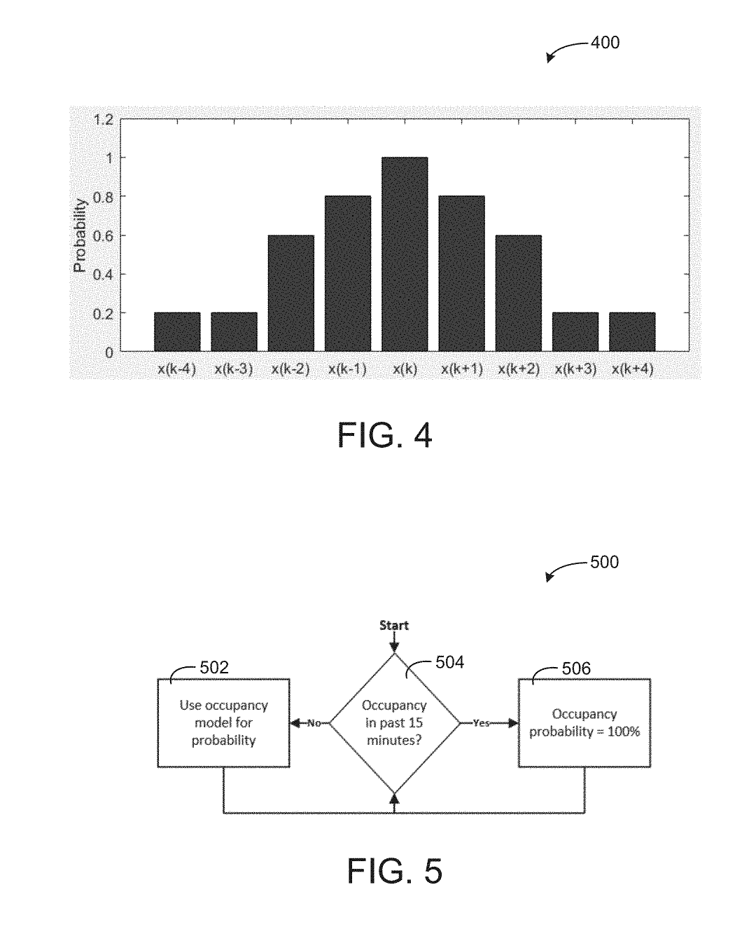

Referring now to FIG. 4, a probability distribution 400 for the occupancy model 314 of the thermostat 10, according to an exemplary embodiment. The probability distribution 400 graphically illustrates Table 3. As can be seen, the probability for nine different time steps (e.g., k−4, k−3, k−2, k−1, k, k+1, k+2, k+3, and k+4) are shown. The time steps may be a particular period of time, e.g., fifteen minute intervals. In an example, at time zero or present time k, x(k) illustrates that the occupancy sensor 12 has detected occupancy, which renders a corresponding probability as 1. The probability distribution indicates that four time steps into the future (e.g., k+1, k+2, k+3, and k+4) are assigned with probabilities as 0.8, 0.6, 0.2, and 0.2, respectively. Similarly, the probability distribution indicates that if occupancy is detected at time zero, the probability distribution indicates that four time steps in the past (e.g., k−1, k−2, k−3, and k−4) are assigned with probabilities as 0.8, 0.6, 0.2, and 0.2, respectively.

Referring now to FIG. 5, a process 500 is shown for operating the thermostat 10 with the occupancy model 314. The thermostat 10 can be configured to perform the process 500 with the processing circuit 302. Specifically, the model selector 312 can be configured to perform the process 500. Further, any computing device described herein can be configured to perform the process of FIG. 5. Regarding the process 500, if occupancy has occurred within the last 15 minutes, the probability of occupancy is 100% for said 15 minute interval. However, if no occupancy has occurred in the past 15 minutes, the occupancy model 314 is used to predict the occupancy in order to account for the sensor's imperfections.

In step 504, the model selector 312 determines, based on occupancy data received form the occupancy sensor 12, whether an occupant is present in within the past fifteen minutes. If occupancy has been detected within the last fifteen minutes, the process 500 performs step 506. In step 506, the model selector 312 causes the HVAC controller 316 to ignore any occupancy determination made by the occupancy model 314 and rather operate as if there is total certainty of an occupant.

In step 504, if no occupancy is detected by the model selector 312 within the last fifteen minutes, the process 500 moves to step 502. In step 502, the model selector 312 causes the model selector 312 to cause the HVAC controller 316 to operate based on occupancy determinations made by the occupancy model 314. Although process 500 is described for a fifteen minute interval, any predefined or dynamic amount of time can be used.

### Occupancy Model Simulation

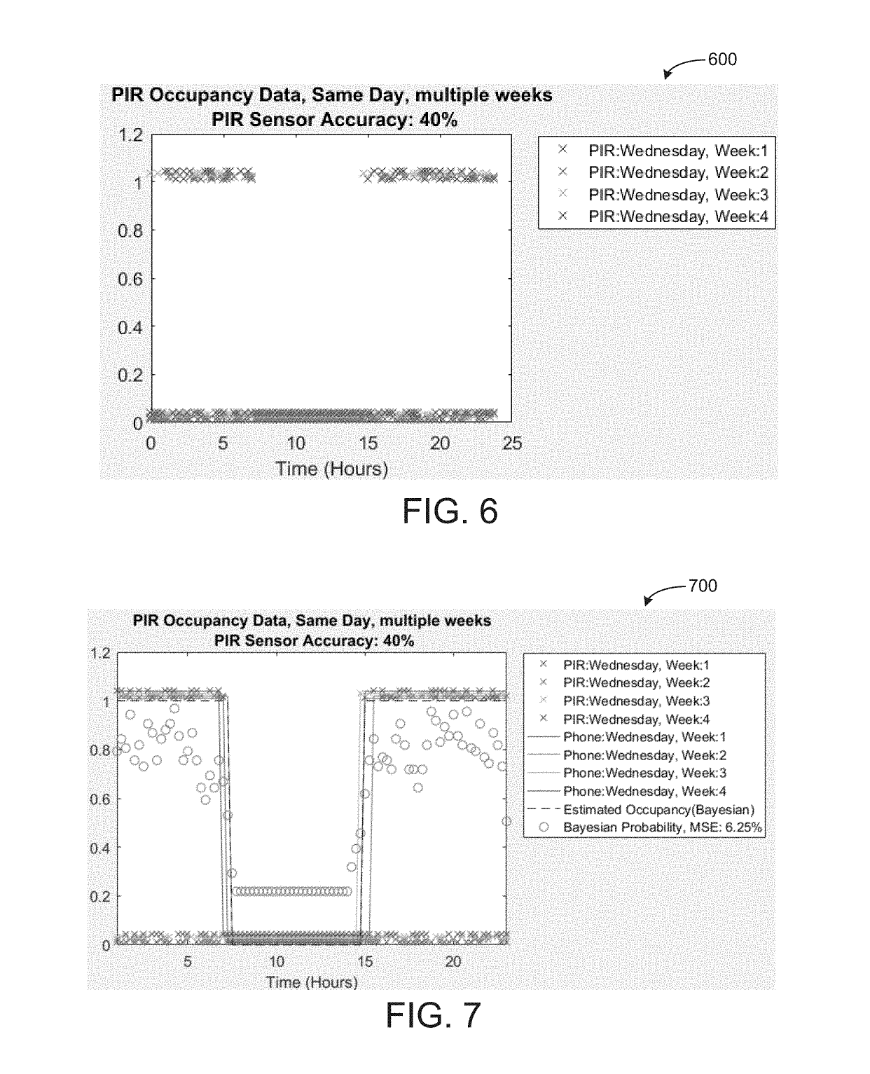

Referring generally to FIGS. 6-8, an example of occupancy data and the performance of the occupancy model 314 is shown, according to an exemplary embodiment. FIGS. 6-7 illustrate a simulation using the occupancy model 314 modeling occupancy based on PIR sensor data (e.g., when the occupancy sensor 12 is a PIR sensor). For this simulation, the occupancy model 314 has a starting assumption that the occupancy sensor 12 will fail to detect occupancy 60% of the time. This is illustrated in Table 4.

TABLE 4
Event Probability For A PIR Sensor

| Event (Failed sensor reading) | Probability |
|---|---|
| PIR = 0 \| Occupancy = 1 | 0.6 |

Using this assumption and an assumption of an 8 A.M. to 5 P.M. work day (i.e., the occupant is not at home between 8 A.M. and 5 P.M. on a given day), the following PIR dataset illustrated in FIG. 6 was generated for a period of 4 weeks. In the simulation, “present” occupancy was determined by rounding on 50% probability of occupancy.

Referring now to FIG. 6, chart 600 illustrates occupancy data that the thermostat 10 can be configured to gather from the occupancy sensor 12. The occupancy data is gathered for a Wednesday of four different weeks illustrated by Week 1, Week 2, Week 3, and Week 4 “x” markers colored blue, red, yellow, and purple respectively.

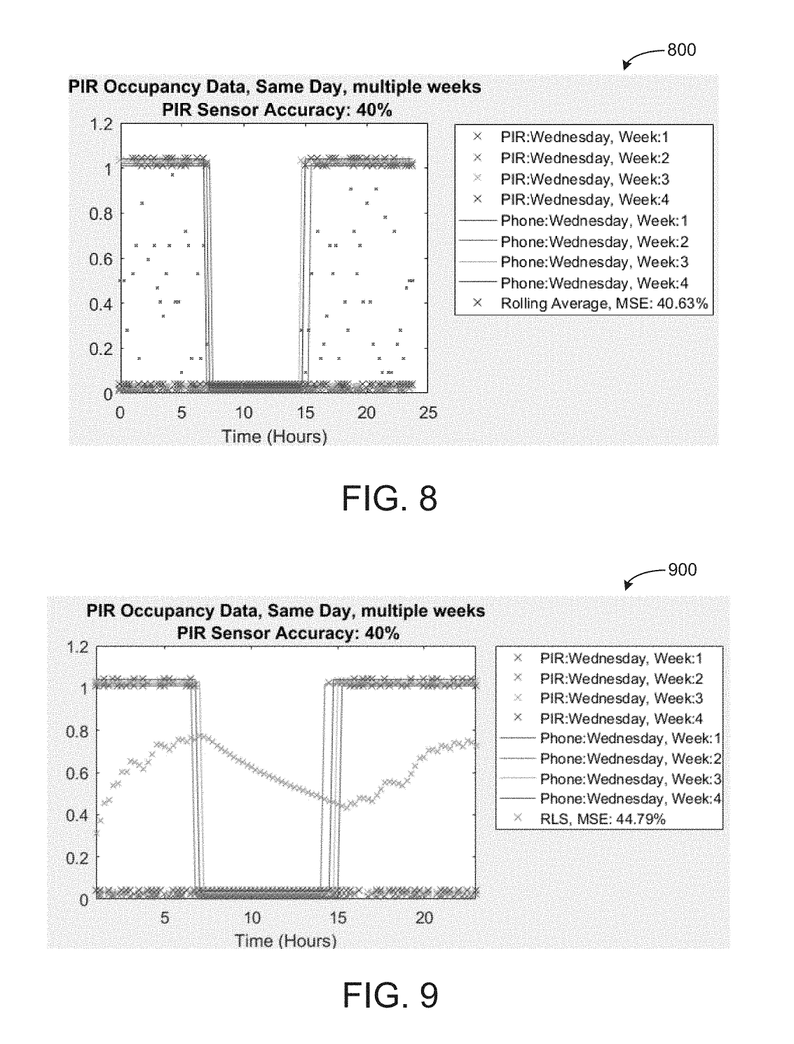

Referring now to FIG. 7, the chart 700 illustrates performance of the occupancy model 314 is shown, according to an exemplary embodiment. Individual occupancy predictions of the occupancy model 314 are illustrated by circles. The estimated occupancy based on the occupancy predictions is illustrated by a dashed line. The estimated occupancy of the occupancy model 314 has a mean-squared error (MSE) of 6.25%. This can be contrasted with other occupancy predictions methods e.g., the occupancy prediction shown in FIG. 8.

FIG. 8 includes chart 800 which illustrates the occupancy prediction of a pure rolling average, according to an exemplary embodiment. The pure rolling average does not apply probabilities according to the categorical distribution of the occupancy model 314. The predictions of the rolling average are shown with dark blue “x” markers. As can be seen, the predictions have large amounts of error. The pure rolling average has a MSE of 40.63%, significantly worse than the predictions of the occupancy model 314 (MSE of 6.25%).

Referring now to FIG. 9, chart 900 illustrates the performance of recursive least squares (RLS) used for performing occupancy predictions is shown, according to an exemplary embodiment. The RLS does not apply probabilities according to the categorical distribution of the occupancy model 314. The predictions of the RLS method are shown with the teal “x” markers in FIG. 9. This will not work since the error is not normally distributed. Furthermore, such a method would introduce significant phase delay. FIG. 9 illustrates the performance of a model where recursive least squares is to ‘train’ the model. Using recursive least squares and training with features based upon time of day, the mean squared error was 47% which is not ideal for practical operation.

Referring generally to FIGS. 6-9, using adjacent data points to more accurately determine the current occupancy state can compensate for the inaccuracies of a PIR sensor (e.g., the occupancy model 314). In addition, combining this method for the occupancy model 314 with past data through rolling averages helps create a reliable method of occupancy determination that is able to adapt overtime. In the simulated dataset of chart 600, the proposed model (e.g., the occupancy model 314) had an accuracy of 94% where as a simple rolling average had an accuracy of 60%.

### Configuration of Exemplary Embodiments

The construction and arrangement of the systems and methods as shown in the various exemplary embodiments are illustrative only. The specific time values and time periods discussed above are exemplary; other values can be utilized. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A thermostat for controlling HVAC equipment of a building based on occupancy of the building, the thermostat comprising:
an occupancy sensor configured to detect a presence of an occupant; and
a processing circuit configured to:
receive occupancy data for one or more points in time from an occupancy sensor, the occupancy data indicating the presence of an occupant at the one or more points in time; and
train an occupancy model based on the occupancy data, wherein the occupancy model predicts a probability of the presence of the occupant.

2. The thermostat of claim 1, wherein the occupancy model is a non-causal model that determines the presence of the occupant at a first point in time based on occupancy data for at least one second point in time before the first point in time and at least one third point in time after the first point in time.

3. The thermostat of claim 1, wherein the processing circuit is configured to train the occupancy model based on a rolling average of the received occupancy data.

4. The thermostat of claim 1, wherein the processing circuit is configured to extend or shorten the home-to-away timeout based on the probability of occupancy determined by the occupancy model, wherein the home-to-away timeout indicates a length of time with no occupancy detected by the occupancy sensor that the thermostat should switch from a home operating mode to an away operating mode.

5. The thermostat of claim 1, wherein the processing circuit is configured to:
determine whether the occupancy data of the occupancy sensor indicates the presence of the occupant during a first interval of time;
determine a value of a first probability as one for the first interval of time in response to the occupancy sensor detecting the presence of the occupant; and
determine a value of a second probability as non-one for the first interval of time in response to the occupancy sensor detecting no presence of the occupant.

6. The thermostat of claim 1, wherein the processing circuit is configured to:
operate the building equipment based on the occupancy model, wherein operating the building equipment based on the occupancy model comprises:
setting an operating mode to home in response to determining, via the occupancy sensor, the presence of the occupant;
setting an operating mode to away in response to determining, via the occupancy sensor, no presence of the occupant for a period of time and the mode being home, wherein the period of time is a home-to-away timeout;
updating the home-to away timeout based on the probability of the presence of the occupant determined by the occupancy model;
operating the building equipment in response to the processing circuit indicating a home mode; and
not operating the building equipment in response to the processing circuit indicating an away mode.

7. A method, comprising:
receiving occupancy data for one or more points in time from an occupancy sensor, the occupancy data indicating a presence of one or more occupants at the one or more points in time in a building space; and
updating an occupancy model based on the occupancy data, wherein the occupancy model predicts a probability of the presence of the one or more occupants.

8. The method of claim 7, wherein the occupancy model is a non-causal model that determines the presence of the occupant at a first point in time based on occupancy data for at least one second point in time before the first point in time and at least one third point in time after the first point in time.

9. The method of claim 7, wherein updating an occupancy model based on the occupancy date further comprises training the occupancy model based on a rolling average of the received occupancy data.

10. The method of claim 7, further comprising:
extending or shortening a home-to-away timeout based on the probability of occupancy determined by the occupancy model, wherein the home-to-away timeout indicates the length of time with no occupancy detected by the occupancy sensor that the thermostat should switch from a home operating mode to an away operating mode.

11. The method of claim 7, further comprising:
determining whether the occupancy data of the occupancy sensor indicates the presence of the occupant during a first interval of time;
determine a value of a first probability as one for the first interval of time in response to the occupancy sensor detecting the presence of the occupant; and
determine a value of a second probability as non-one for the first interval of time in response to the occupancy sensor detecting no presence of the occupant.

12. The method of claim 7, further comprising:
operating the building equipment based on the occupancy model.

13. The method of claim 12, wherein operating the building equipment based on the occupancy model further comprises:
switching to a home operating mode in response to determining, via the occupancy sensor, the presence of the occupant;
switching to an away operating mode from the home operating mode in response to determining, via the occupancy sensor, no presence of the occupant for a period of time, wherein the period of time is a home-to-away timeout;
updating the home-to away timeout based on the probability of the presence of the occupant determined by the occupancy model;
operating the building equipment in response to the processing circuit indicating a home mode; and
not operating the building equipment in response to the processing circuit indicating an away mode.

14. A thermostat for controlling HVAC equipment of a building based on occupancy of the building, the thermostat comprising:
an occupancy sensor configured to detect an occupant in a building space; and
a processing circuit configured to:
receive data from the occupancy sensor indicating whether the occupant is at presence in the building space over a plurality of time bins; and
train an occupancy model based on the data by subsequently determining a probability of presence of the occupant at a first one of the plurality of time bins based on whether the occupant has been at presence in the building space over at least one of the plurality of time bins, which is prior to the first one of the plurality of time bins, and over at least one of the plurality of time bins, which is subsequent to the first one of the plurality of time bins, and predicting a probability of presence of the occupant at the first one of the plurality of time bins in a future using the determined probability of presence of the occupant.

15. The thermostat of claim 14, wherein the processing circuit is configured to train the occupancy model based on a rolling average of the received data.

16. The thermostat of claim 14, wherein the processing circuit is configured to assign the probability of presence of the occupant as a non-one value, responsive to the occupancy sensor detecting no presence of the occupant in the building space at the first one of the plurality of time bins.

17. The thermostat of claim 16, wherein the processing circuit is configured to assign the non-one value according to a predefined table in which the non-one value is determined according to whether the occupant has been at presence in the building space over the at least one of the plurality of time bins, prior to the first one of the plurality of time bins, and over the at least one of the plurality of time bins, subsequent to the first one of the plurality of time bins.

18. The thermostat of claim 14, wherein the processing circuit is configured to extend or shorten a home-to-away timeout based on the probability of occupancy determined by the occupancy model, wherein the home-to-away timeout indicates a length of time with no occupancy detected by the occupancy sensor that the thermostat should switch from a home operating mode to an away operating mode.

19. The thermostat of claim 14, wherein the processing circuit is configured to operate the building equipment based on the occupancy model.

20. The thermostat of claim 19, wherein the processing circuit is configured to:
switch the building equipment to a home operating mode in response to determining, via the occupancy sensor, the presence of the occupant;
switch the building equipment to an away operating mode from the home operating mode in response to determining, via the occupancy sensor, no presence of the occupant for a period of time, wherein the period of time is a home-to-away timeout;
update the home-to away timeout based on the probability of the presence of the occupant determined by the occupancy model;
operate the building equipment in response to the processing circuit indicating a home mode; and
not operate the building equipment in response to the processing circuit indicating an away mode.
